(19) United States
(12) Patent Application Publication
(10) Pub. No.: US 2014/0208850 A1
(43) Pub. Date: Jul. 31, 2014

(54) APPARATUS AND METHOD OF DETECTING A DEFECT OF A SEMICONDUCTOR DEVICE

(71) Applicants: Geun-woo Kim, Chungcheongnam-do (KR); Hyun Kim, Chungcheongnam-do (KR); Yun-sik Yoo, Gyeonggi-do (KR); Sang-jun Kim, Chungcheongnam-do (KR); Jae-yong Park, Chungcheongnam-do (KR); Tae-gyeong Chung, Gyeonggi-do (KR)

(72) Inventors: Geun-woo Kim, Chungcheongnam-do (KR); Hyun Kim, Chungcheongnam-do (KR); Yun-sik Yoo, Gyeonggi-do (KR); Sang-jun Kim, Chungcheongnam-do (KR); Jae-yong Park, Chungcheongnam-do (KR); Tae-gyeong Chung, Gyeonggi-do (KR)

(21) Appl. No.: 13/753,111

(22) Filed: Jan. 29, 2013

(51) Int. Cl. G01N 29/14

(52) U.S. Cl. CPC G01N 29/14
USPC 73/587

(57) ABSTRACT

A semiconductor device defect detecting apparatus including: a sensor disposed on semiconductor process equipment, the sensor configured to detect a signal emitted from a semiconductor device in contact with the semiconductor process equipment; and a signal analyzer configured to determine whether the semiconductor device is defective based on the detected signal in a predetermined frequency range.

### BACKGROUND

1. Technical Field

The inventive concept relates to semiconductor devices and methods of manufacturing the same, and more particularly, to an apparatus and method of detecting a defect of a semiconductor device.

2. Discussion of the Related Art

To meet the demand for semiconductor devices with high-speed operations and large-capacity data storage, semiconductor device manufacturing technology has been developed. In addition, semiconductor device manufacturing technology has been developed to meet the demand for thin semiconductor devices. However, as the thicknesses of semiconductor packages, wafers and chips become smaller, there is an increase in cracking, pattern deformation, or the like occurring in a semiconductor package, a wafer or a chip in a semiconductor device manufacturing process.

### SUMMARY

Exemplary embodiments of the inventive concept provide a semiconductor device defect detecting apparatus and a semiconductor device defect detecting method capable of detecting a defect of a semiconductor device in real time while a semiconductor process is being conducted.

According to an exemplary embodiment of the inventive concept, there is provided a semiconductor device defect detecting apparatus including: a sensor disposed on semiconductor process equipment, the sensor configured to detect a signal emitted from a semiconductor device in contact with the semiconductor process equipment; and a signal analyzer configured to determine whether the semiconductor device is defective based on the detected signal in a predetermined frequency range.

The sensor is an acoustic emission sensor.

The predetermined frequency range is from 20 kHz to 300 kHz.

The semiconductor device is determined to be defective when a time range between appearance and disappearance of the detected signal is within 0.1 second in the predetermined frequency range.

The semiconductor device is determined to be defective when a threshold voltage of the detected signal or a threshold energy of the detected signal is exceeded in the predetermined frequency range.

The signal is emitted from the semiconductor device when the semiconductor device is processed by the semiconductor process equipment.

The apparatus further includes a controller configured to stop the semiconductor process equipment when the semiconductor device is determined to be defective.

According to an exemplary embodiment of the inventive concept, there is provided a semiconductor device defect detecting apparatus including: a sensor disposed on a chuck table of semiconductor process equipment, the sensor configured to detect a signal emitted from a semiconductor device in contact with the chuck table; and a signal analyzer configured to analyze the detected signal to determine whether the semiconductor device is defective by using a predetermined criteria.

The sensor is an acoustic emission sensor.

The chuck table is metal or ceramic.

The predetermined criteria include a threshold voltage of acoustic waves, a threshold energy of the acoustic waves and a frequency range of the acoustic waves, wherein the semiconductor device is determined to be defective when a threshold voltage of the detected signal and a threshold energy of the detected signal are exceeded in a predetermined frequency range.

The apparatus further includes a controller configured to stop the semiconductor process equipment when the semiconductor device is determined to be defective.

According to an exemplary embodiment of the inventive concept, there is provided a method for detecting a defect in a semiconductor device including: detecting, in real-time, a signal emitted from a semiconductor device being processed by and in contact with semiconductor process equipment, wherein the detecting is performed by a sensor disposed on the semiconductor process equipment; and determining, whether the semiconductor device is defective based on the detected signal in a predetermined frequency range, wherein the determining is performed by a signal analyzer.

The sensor is an acoustic emission sensor.

The semiconductor device is determined to be defective when a threshold voltage of the detected signal or a threshold energy of the detected signal is exceeded in the predetermined frequency range.

The method further includes stopping the semiconductor process equipment when the semiconductor device is determined to be defective, wherein the stopping is performed by a controller.

According to an exemplary embodiment of the inventive concept, there is provided a method for detecting a defect in a semiconductor device including: detecting, in real time, a signal emitted from a semiconductor device in contact with a chuck table of semiconductor process equipment, wherein the detecting is performed by a sensor disposed on the chuck table of the semiconductor process equipment; and analyzing the detected signal to determine whether the semiconductor device is defective by using a predetermined criteria, wherein the analyzing is performed by a signal analyzer.

The sensor is an acoustic emission sensor.

The chuck table is metal or ceramic.

The predetermined criteria include a threshold voltage of acoustic waves, a threshold energy of the acoustic waves and a frequency range of the acoustic waves, wherein the semiconductor device is determined to be defective when a threshold voltage of the detected signal and a threshold energy of the detected signal are exceeded in a predetermined frequency range.

The method further includes stopping the semiconductor process equipment when the semiconductor device is determined to be defective, wherein the stopping is performed by a controller.

According to an exemplary embodiment of the inventive concept, there is provided a method for detecting a defect in a semiconductor device including: detecting, in real time, a signal emitted from a semiconductor device in contact with a chuck table of semiconductor process equipment, wherein the detecting is performed by at least three sensors disposed on the chuck table of the semiconductor process equipment; determining whether the semiconductor device is defective based on the detected signal, wherein the determining is performed by a signal analyzer; storing information about a location of a defect in the semiconductor device, wherein the storing is performed by a controller; and skipping, based on the stored information, a subsequent process to be performed on the location of the defect by another semiconductor process equipment, wherein the skipping is performed by the controller.

The location of the defect in the semiconductor device is detected based on signals output from the at least three sensors.

### BRIEF DESCRIPTION OF THE DRAWINGS

The above and other features of the inventive concept will become more apparent by describing in detail exemplary embodiments thereof with reference to the accompanying drawings in which:

FIG. 1A is a block diagram of a semiconductor device defect detecting apparatus according to an exemplary embodiment of the inventive concept;

FIG. 1B is a block diagram of a signal conditioning unit included in the semiconductor device defect detecting apparatus of FIG. 1A, according to an exemplary embodiment of the inventive concept;

FIG. 2 is a diagram illustrating the use of acoustic emission (AE) waves in the semiconductor device defect detecting apparatus of FIG. 1A to detect a defect of a semiconductor device, according to an exemplary embodiment of the inventive concept;

FIG. 3 is a diagram illustrating an application of the semiconductor device defect detecting apparatus of FIG. 1A to tape mounting equipment, according to an exemplary embodiment of the inventive concept;

FIGS. 4A and 4B are graphs for explaining a method in which the semiconductor device defect detecting apparatus of FIG. 1A detects a defect of a semiconductor device, according to an exemplary embodiment of the inventive concept;

FIG. 5 is a diagram illustrating the use of ultrasonic waves in the semiconductor device defect detecting apparatus of FIG. 1A to detect a defect of a semiconductor device, according to an exemplary embodiment of the inventive concept;

FIGS. 6 and 7 are diagrams illustrating a principle that a semiconductor device defect detecting apparatus according to an exemplary embodiment of the inventive concept detects a defect-occurred location by using at least three AE sensors;

FIGS. 8 through 11 are cross-sectional views of semiconductor process equipment that may use the semiconductor device defect detecting apparatus of FIG. 1A, and sensors mounted on the semiconductor process equipment, according to exemplary embodiments of the inventive concept;

FIGS. 12 and 13 are block diagrams of semiconductor manufacturing systems including semiconductor device defect detecting apparatuses, according to exemplary embodiments of the inventive concept;

FIGS. 14A and 14B are flowcharts of semiconductor device defect detecting methods that use an AE sensor, according to exemplary embodiments of the inventive concept; and

FIG. 15 is a flowchart of a semiconductor device defect detecting method that uses an ultrasonic sensor, according to an exemplary embodiment of the inventive concept.

### DETAILED DESCRIPTION OF THE EMBODIMENTS

Hereinafter, exemplary embodiments of the inventive concept will be described in detail with reference to the accompanying drawings. The inventive concept may, however, be embodied in many different forms and should not be construed as limited to the embodiments set forth herein.

When an element is referred to as being “connected” to another element, it can be directly connected to the other element or intervening elements may be present. When an element is referred to as being “on” another element, the element can be directly on another element or intervening elements may be present. In the drawings, the structure or size of each element may be exaggerated for clarity. Like numbers may refer to like elements throughout the specification and drawings.

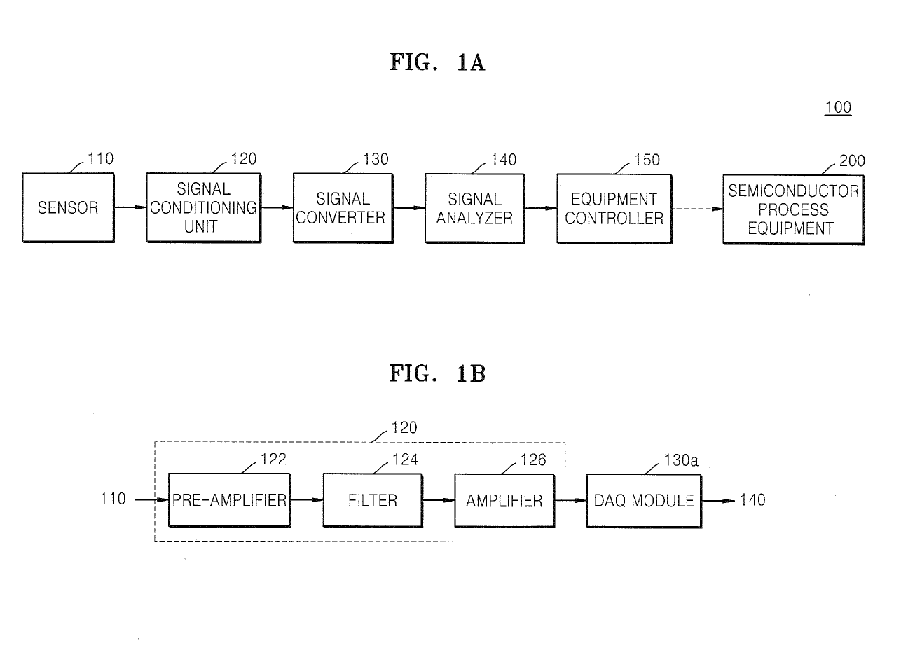

FIG. 1A is a block diagram of a semiconductor device defect detecting apparatus 100 according to an exemplary embodiment of the inventive concept.

Referring to FIG. 1A, the semiconductor device defect detecting apparatus 100 may include a sensor 110, a signal conditioning unit 120, a signal converter 130, a signal analyzer 140, and an equipment controller 150.

The sensor 110 senses a physical signal, such as a temperature, a pressure, or a vibration, and converts the physical signal into a measurable electrical signal, for example, a voltage or a current. Examples of the sensor 110 may include a magnetic sensor, a dynamic sensor, an optical sensor, an audio sensor, a temperature sensor, and the like.

Examples of the magnetic sensor may include a magnetic diode, a magnetic resistance device, and the like, and examples of the dynamic sensor may include an acceleration sensor, a level sensor, a density sensor, a displacement sensor, a speed sensor, a strain gage, a pressure sensor, a flow sensor, a flow velocity sensor, a torque sensor, a load sensor, and the like. Examples of the optical sensor may include a brightness sensor, a laser sensor, an ultraviolet (UV) sensor, an infrared (IR) sensor, and the like, examples of the audio sensor may include a noise sensor, a vibration sensor, an acoustic emission (AE) sensor, an ultrasonic sensor, and the like, and examples of the temperature sensor may include a thermo-couple, a thermister, a resistance thermometer (e.g., PT-100), and the like.

The sensor 110 used in the semiconductor device defect detecting apparatus 100 may be an AE sensor or an ultrasonic sensor. However, the sensor 110 of the semiconductor device defect detecting apparatus 100 is not limited to an AE sensor or an ultrasonic sensor. For example, any sensor such as a vibration sensor or an IR sensor may be used in the semiconductor device defect detecting apparatus 100 as long as it has no physical effect on a semiconductor device or a wafer which is to be tested and as long as it has no physical effect on equipment used for performing a process with respect to the semiconductor device or wafer.

For reference, a sound is generated when an object is destroyed, and a sound generated during an internal micro-destruction of an object is referred to as an AE or an AE wave. Theoretically, the AE wave denotes an elastic wave emitted from an object during atom re-arrangement when the object is deformed. A sensor that senses an AE wave is an AE sensor, a piezo-electric or electrostrictive vibrator may be used as the AE sensor, and AE sensors may be classified as an unbalanced sensor and a differential sensor according to their structure.

An ultrasonic sensor uses ultrasounds that are sounds having a sufficiently high frequency (e.g., about 20 kHz or higher) which can be barely heard by a human. Ultrasounds may be used in air, liquids, or solids, and may contribute to measuring high resolving power because they have a high frequency and a short wavelength. A wavelength to be used in an ultrasonic sensor is determined according to the sound speed of a medium and the frequency of a sound wave, and ranges from about 1 mm to about 100 mm in fish finders or sonars, from about 0.5 mm to about 15 mm in metal inspection, and from about 5 mm to about 35 mm in air. An ultrasonic sensor includes a transmitting device which transmits ultrasounds and a receiving device which receives ultrasounds, and may be formed of a magnetostrictive material (e.g., ferrite) or an electrostrictive material (e.g., Rochelle salt, barium titanate, or the like).

There are many types of ultrasonic sensors, which may be categorized as a velocity measurement sensor, a distance measurement sensor, a concentration and/or viscosity sensor, and an internal probing sensor according to their application. The semiconductor device defect detecting apparatus 100 may use an internal probing sensor, examples of which may include an ultrasonic fault detecting probe, an ultrasonic thickness gauge, an ultrasonic microscope, ultrasonic diagnostic equipment, an ultrasonic computerized tomography (CT) scanner, and the like.

The signal conditioning unit 120 may perform conditioning, for example, signal amplification and/or noise removal, on a signal output from the sensor 110. The signal output from the sensor 110 may be very weak and/or may include many noises. Accordingly, the signal output by the sensor 110 may be converted into a signal suitable for analysis via the conditioning performed on the signal by the signal conditioning unit 120. The signal conditioning unit 120 may be built in the sensor 110. When the signal conditioning unit 120 is built in the sensor 110, the sensor 110 may be directly connected to the signal converter 130, for example, a data acquisition (DAQ) module.

In some cases, the signal conditioning unit 120 may not be included. For example, when a signal to be sensed is easily distinguished from a noise or the signal rarely includes noises, the signal conditioning unit 120 may not be included. In addition, the signal conditioning unit 120 may not be included if the signal analyzer 140 performs a function of removing unnecessary noises. The signal conditioning unit 120 will be described in greater detail later with reference to FIG. 1B.

The signal converter 130 may convert the signal output by the sensor 110 or a signal obtained by the conditioning performed in the signal conditioning unit 120 into a digital signal. In other words, the signal converter 130 may convert the signal output from the sensor 110 and/or the signal conditioning unit 120 into a digital signal that is recognizable by a signal analyzer such as a personal computer (PC).

The signal converter 130 may generally include an analog to digital convertor (ADC) chip, and may be implemented by using any of various bus type DAQ modules such as Peripheral Component Interconnect (PCI), PCI Express (PCle), PCI eXtentions for Instrumentation (PXI), PXI Express (PXIe), Personal Computer Memory Card International Association (PCMCIA), Universal Serial Bus (USB), and Firewire.

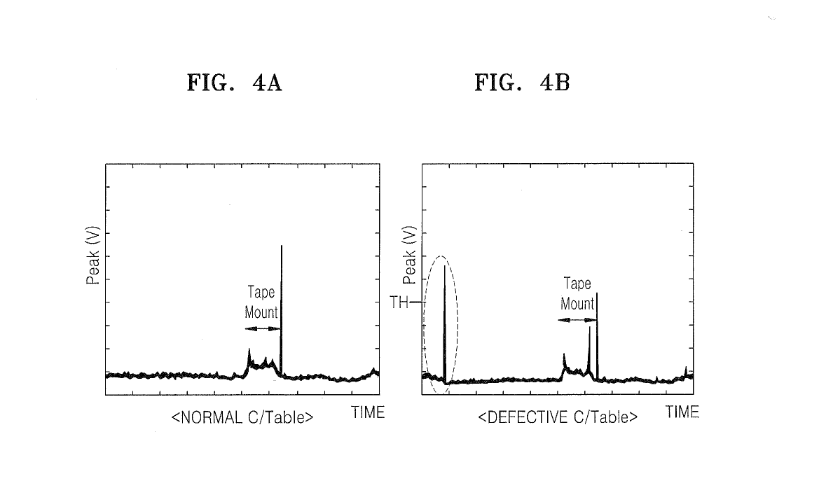

The signal analyzer 140 may determine whether a semiconductor device or a wafer is defective, by analyzing the digital signal output by the signal converter 130. The signal analyzer 140 may be implemented by installing a corresponding analysis program on a computer, such as a desktop PC, a notebook, a PXI, and a Programmable Automation Controller (PAC), in which an Operating System (OS), for example, Windows, LINUX, or Real Time (RT), is included. The determination of whether a semiconductor device or a wafer is defective by the signal analyzer 140 will be described in greater detail later with reference to FIG. 4.

The equipment controller 150 may control corresponding semiconductor process equipment in response to a result of the determination about the semiconductor device or the wafer by the signal analyzer 140. For example, when a defect, such as cracking or pattern deformation, is generated while semiconductor process equipment is conducting a process on the semiconductor device or the wafer, a signal corresponding to the defect may be transmitted to the signal analyzer 140 via the sensor 110, the signal conditioning unit 120, and the signal converter 130. The signal analyzer 140 may determine whether the semiconductor device or the wafer is defective, by analyzing the received signal according to a predetermined rule. If the semiconductor device or the wafer is determined to be defective, the signal analyzer 140 may transmit a defect generation signal to the equipment controller 150.

When the equipment controller 150 receives the defect generation signal, it may interrupt an operation of semiconductor process equipment 200 used in the process performed on the semiconductor device or the wafer, by using a control signal.

The pattern deformation denotes a case where no cracks are generated in a semiconductor device or a wafer but a direct current (DC) test failure is caused by local deformation of an integrated circuit. Only cracking and pattern deformation were mentioned above as defects of a semiconductor device or a wafer, but the defects of a semiconductor device or a wafer may be any type of physical deformation as long as it causes the semiconductor device or the wafer to electrically malfunction. Therefore, although only cracking or pattern deformation of a semiconductor device or a wafer is described below, it will be understood as including defects of a semiconductor device or a wafer that are caused by other forms of physical deformation.

In addition, the term “a semiconductor device or a wafer” was mentioned above, but the semiconductor device may denote an individual chip and the wafer may denote a wafer that has not yet been divided into individual chips. Accordingly, a semiconductor device or a wafer will now be collectively referred to as a semiconductor device for convenience of explanation, except for cases where a wafer is solely mentioned.

Moreover, the semiconductor device defect detecting apparatus 100 is not limited to a semiconductor device or a wafer, and may be used to detect in real time a defect of a test target that may have cracks or deformation occurring during various processes. For example, for detecting a defect of a liquid crystal display (LCD) substrate, a flexible substrate, a display substrate, a glass substrate, a ceramic substrate, a sapphire substrate, or the like, the semiconductor device defect detecting apparatus 100 may be applied to process equipment during the manufacture of each of these substrates to detect the defect in real time. A semiconductor device may be understood hereinafter as including any test target.

When a defect such as cracking or pattern deformation is generated during a process involving a semiconductor device, for example, manufacturing, evaluation, or transportation of the semiconductor device, the semiconductor device defect detecting apparatus 100 may detect the defect in real time by using an AE sensor or the like and immediately interrupt an operation of semiconductor process equipment, thereby minimizing the occurrence of defects of the semiconductor device and optimizing the efficiency of the semiconductor process equipment. For example, in back lap (B/L) equipment, when particles exist on a chuck table that supports a wafer, cracks may be consecutively generated at identical locations on about 100 to 200 wafers if the particles are not removed. However, in general, since the detection of such cracks does not occur during a semiconductor process and these cracks are detected after a DC test on semiconductor devices, several hundreds to thousands of semiconductor devices are determined to be defective and are discarded. However, since the semiconductor device defect detecting apparatus 100 according to the present embodiment detects a defect in real time, e.g., while the defect is generated, and can interrupt an operation of B/L equipment in response to an indication that the defect has been detected, the particles that caused the defect can be removed, and thus the semiconductor device defect detecting apparatus 100 may minimize the occurrence of defects in a wafer in a B/L process and may optimize the efficiency of the B/L equipment.

FIG. 1B is a block diagram of the signal conditioning unit 120 of the semiconductor device defect detecting apparatus 100 of FIG. 1A, according to an exemplary embodiment of the inventive concept.

Referring to FIG. 1B, the signal conditioning unit 120 may include a pre-amplifier 122, a filter 124, and an amplifier 126. The pre-amplifier 122 is used to increase the level of a signal to a suitable level when the signal level is too low to be used as an input of the amplifier 126. The pre-amplifier 122 provides a suitable input/output impedance without lowering a signal to noise (S/N) ratio and increases the level of a signal to an extent that the signal can be easily processed later. From time to time, the pre-amplifier 122 may perform synchronization, mixing, or the like of signals. If the level of the signal output by the sensor 110 is enough to be used as an input of the amplifier 126, the pre-amplifier 122 may not be included.

The filter 124 is a circuit that easily passes some frequency bands and blocks the other frequency bands, and it generally may be installed to remove noises unnecessary for signal analysis. Noises associated with a semiconductor process may be a white noise, equipment noise, and the like. The equipment noise denotes noise that is specifically generated in corresponding process equipment. Filters may be classified as a high pass filter, a low pass filter, a band pass filter, a band rejection filter, a notch filter, and the like according to frequency characteristic curves.

Although the signal conditioning unit 120 according to the present embodiment includes the filter 124, it may not include the filter 124 when there is no need to remove noises, such as, when a difference between a noise and a signal which is to be detected is clear or when a signal rarely includes noises.

The amplifier 126 amplifies an input signal by using a circuit such as a transistor or a field effect transistor (FET). The transistor or the FET increases the amplitude of an output signal by increasing the energy of an input signal by using electrical energy provided by a power supply source. An amplified signal obtained by the amplifier 126 is input to a DAQ module 130a, thus facilitating signal conversion which is performed in the DAQ module 130a. For reference, since a DAQ module is frequently used as a signal converter, the signal converter 130 of FIG. 1A is referred to as the DAQ module 130a in FIG. 1B.

The signal conditioning unit 120 may perform an isolation function of electrically separating an input signal from an output signal, to protect the DAQ module 130a from a high voltage or other noises that enter(s) via a signal line.

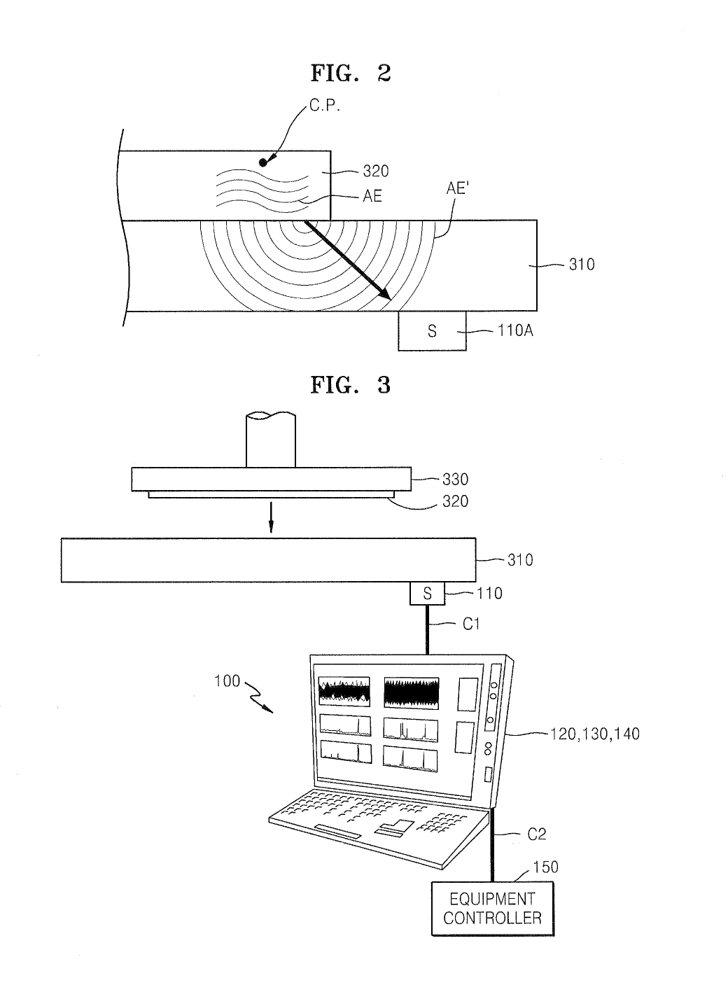

FIG. 2 is a diagram illustrating the use of AE waves in the semiconductor device defect detecting apparatus 100 of FIG. 1A to detect a defect of a semiconductor device, according to an exemplary embodiment of the inventive concept.

Referring to FIG. 2, a semiconductor device 320 is disposed on semiconductor process equipment 310, for example, on a chuck table for a B/L process, so that a process may be conducted on the semiconductor device 320. An AE sensor 110A used in the semiconductor device defect detecting apparatus 100 may also be installed on the semiconductor process equipment 310.

When a crack is generated in the semiconductor device 320 for some reason during a B/L process, AE waves AE are generated from a crack point C.P. The AE waves AE travel by using the semiconductor device 320 as a medium to reach the semiconductor process equipment 310, and continuously travel by using the semiconductor process equipment 310 as a new medium. Thereafter, the AE sensor 110A mounted on the semiconductor process equipment 310 detects AE waves AE′ received via the semiconductor process equipment 310. The detected AE waves AE′ may be input to the signal analyzer 140 via the signal conditioning unit 120 and/or the signal converter 130 by wire, such as, via a cable, or wirelessly.

When the medium is changed from the semiconductor device 320 to the semiconductor process equipment 310, the wavelength of the AE waves AE may be changed. For example, the AE waves AE′ in the semiconductor process equipment 310 may have a longer or shorter wavelength than the AE waves AE in the semiconductor device 320. In general, a wavelength of a wave increases as the density of a medium increases. Accordingly, AE waves in a medium with a high density may propagate fast and may be less subject to wave deformation or noises.

The AE sensor 110A in the present embodiment may be mounted on semiconductor process equipment formed of a material with a relatively high density or hardness such as a metal or a ceramic. The AE sensor 110A may also be mounted on semiconductor process equipment that directly contacts the semiconductor device 320 to receive the AE waves AE generated from the semiconductor device 320 rapidly and without transformation. In other words, when the AE sensor 110A is used in the semiconductor device defect detecting apparatus 100, it may be mounted on any semiconductor process equipment that physically contacts a semiconductor device and any semiconductor process equipment formed of a material with a relatively high density or hardness.

For reference, a case where an AE sensor is mounted directly on a test target such as a semiconductor device, a wafer, or the like may be considered. However, in this case, an AE sensor may have to be attached to and detached from each test target during a semiconductor process, and thus the semiconductor process may become complicated and may be delayed, thereby leading to a significant reduction in process yield. Moreover, when defect detection is performed in units of dies like a die attaching process, it may be considered that installation of an AE sensor on each die is impractical.

In contrast, in the present embodiment, since an AE sensor is mounted on process equipment to detect a defect of a test target, the installation of the AE sensor is irrelevant to the execution of a semiconductor process. Therefore, the reduction in process yield may be prevented. For example, since a sensor may be disposed on a chuck table it is not necessary to attach or detach the sensor when a wafer is repeatedly loaded on the chuck table during a semiconductor process, thereby improving productivity. In addition, even when defect detection is performed in units of dies like a die attaching process, an AE sensor may be installed on only equipment corresponding to the die attaching process, and thus a defect of each die may be easily detected.

FIG. 3 is a diagram illustrating an application of the semiconductor device defect detecting apparatus 100 of FIG. 1A to tape mounting equipment, according to an exemplary embodiment of the inventive concept.

Referring to FIG. 3, the semiconductor device defect detecting apparatus 100 is applied to the tape mounting equipment. As described above, the semiconductor device defect detecting apparatus 100 may include the sensor 110, the signal conditioning unit 120, the signal converter 130, the signal analyzer 140, and the equipment controller 150.

The sensor 110 may be mounted on a chuck table 310 of the tape mounting equipment. The sensor 110 may be, for example, an AE sensor or an ultrasonic sensor. As depicted in FIG. 3, the signal conditioning unit 120, the signal converter 130, and the signal analyzer 140 may be built in a computer such as a PC, and the sensor 110 may be electrically connected to the signal conditioning unit 120 via a cable C1. The equipment controller 150 may be electrically connected to the signal analyzer 140 via a cable C2. Alternatively, the sensor 110 or the equipment controller 150 may be wirelessly connected to the signal conditioning unit 120 or the signal analyzer 140.

The tape mounting equipment may include the chuck table 310 for supporting a wafer 320, and a hand 330 for moving the wafer 320 toward the chuck table 310. A tape mounting process starts by picking up the wafer 320 via the hand 330 and loading the wafer 320 onto the chuck table 310 after a B/L process, and substantially progresses by attaching a tape of a ring mount to the wafer 320 supported by the chuck table 310.

The loading of the wafer 320 onto the chuck table 310 may progress in such a way that the wafer 320 is separated from the hand 330, placed on the chuck table 310, and vacuum-absorbed by the chuck table 310 to be firmly supported thereby. When a foreign material, for example, particles, exist on the chuck table 310, cracking or pattern deformation of a wafer may occur due to the particles during vacuum absorption, and AE waves are generated when the cracking or the pattern deformation occurs. Accordingly, to detect the AE waves, the sensor 110, for example, an AE sensor, may be mounted on the chuck table 310.

Although the sensor 110 is mounted on a bottom surface of the chuck table 310 in FIG. 3, it may be mounted on a lateral or upper surface of the chuck table 310. The hand 330 picks up the wafer 320 via vacuum absorption, like the chuck table 310 vacuum-absorbs the wafer 320. Accordingly, the cracking or the pattern deformation of the wafer 320 may occur while the hand 330 is picking up the wafer 320. Although not depicted in FIG. 3, a sensor may also be mounted on the hand 330. Although not depicted in FIG. 3, a protective tape may be attached to a surface of the wafer 320 facing the chuck table 310, for example, to an active surface of the wafer 320.

FIGS. 4A and 4B are graphs for explaining a method in which the semiconductor device defect detecting apparatus 100 of FIG. 1A detects a defect of a semiconductor device, according to an exemplary embodiment of the inventive concept. In FIGS. 4A and 4B, the x axis indicates time, and the y axis indicates a voltage level of a signal.

The graph of FIG. 4A shows an AE wave when a tape mounting process is performed in a normal chuck table, and the graph of FIG. 4B shows an AE wave when a tape mounting process is performed in a defective chuck table.

The tape mounting process denotes a process of attaching a tape on a rear surface of a wafer to perform a die sawing process of dividing a wafer into dies, after a B/L process, for example, back surface polishing, is performed on the wafer. This tape mounting process may be achieved by loading a wafer onto a chuck table and then attaching a tape existing inside a ring mount or a ring frame to a rear surface of the wafer by using a tape roller.

Since the tape mounting process is a physical process of attaching a tape to a wafer as described above, AE waves may be generated. Accordingly, it can be seen from the graphs of FIGS. 4A and 4B that AE waves are generated in a tape mount section (indicated by a bi-directional arrow) corresponding to a section during which a tape is attached. In FIGS. 4A and 4B, a waveform with a somewhat constant level in respective lower parts may be understood as a white noise and/or an equipment wave, and a sharply protruding waveform with a high level may be understood as an AE wave.

In a section before the tape mount section, a wafer is loaded on a chuck table and firmly supported thereby. When the wafer is loaded, vacuum absorption by a chuck table may be generally performed. When the chuck table is normal during the vacuum absorption, no abrupt AE waves are generated. On the other hand, when the chuck table is defective, for example, when particles of a predetermined size exist on the chuck table, a crack may be generated in the wafer during the vacuum absorption, and an abrupt AE wave (indicated by a dotted circle of the graph of FIG. 4B) may be generated due to the crack generation. For reference, a tape mounting process may be performed after a wafer is loaded onto a chuck table and vacuum-absorbed by the chuck table.

When AE waves are generated during vacuum absorption, the semiconductor device defect detecting apparatus 100 of FIG. 1A may determine that a wafer loaded onto a chuck table is defective. Since AE waves may also be generated in the tape mount section as described above, the semiconductor device defect detecting apparatus 100 of FIG. 1A may analyze a signal for each process section, and may determine a wafer to be defective, only when AE waves are generated in a set process section, for example, in a wafer-loading process section in which the wafer is loaded onto a chuck table and vacuum absorbed. Although only a vacuum absorption process has been illustrated above, a crack may also be generated in a wafer by the weight of a hand when the hand loads the wafer onto a defective chuck table.

It may not be necessary to automatically determine that a wafer is defective when AE waves generated due to vacuum absorption are so weak that cracking or pattern deformation does not occur in the wafer or when a very low-level AE waves are generated for the other reasons. Accordingly, a criterion for defect determination, for example, a threshold voltage TH of AE waves, may be set, and a wafer may be determined to be defective when generated AE waves exceed the threshold voltage TH. For example, the threshold voltage TH may be in the range of about 1 V to about 2 V. However, the threshold voltage TH is not limited thereto, and may vary according to several factors. For example, the threshold voltage TH may be set in consideration of the level of white noises and/or equipment waves, the degree of amplification performed by an amplifier, and/or the average level of AE waves generated due to cracking.

Criteria other than a threshold voltage may be used as criteria for determining whether a wafer or a semiconductor device is defective. For example, whether a wafer or a semiconductor device is defective may be determined according to whether energy of AE waves calculated in units of sections exceeds a threshold energy. In more detail, the energy of AE waves is calculated at intervals of 0.1 seconds and is compared with a threshold energy of about 1,000 aJ (attojoule) to about 10,000 aJ to determine whether a wafer or a semiconductor device is defective. Whether a wafer or a semiconductor device is defective may also be determined according to whether AE waves belong to a predetermined cycle or a predetermined frequency range. For example, when a signal that has a higher value in a frequency band of 100 kHz or less than in other frequency bands and peaks around 50 kHz is detected, a wafer or a semiconductor device may be determined to be defective.

The semiconductor device defect detecting apparatus 100 of FIG. 1A may determine whether a wafer or a semiconductor device is defective, based on at least one of a threshold voltage, a threshold energy, and a specific frequency range. In some cases, when AE waves exceed a threshold voltage and threshold energy and they belong to a specific frequency band, the semiconductor device defect detecting apparatus 100 may use this criteria to determine a wafer or a semiconductor device to be defective. For example, when AE waves exceed a threshold of 1.5 V and a threshold energy of 2000 aJ, have a higher value in the frequency band of 100 kHz or less than in other frequency bands, and peak around 50 kHz, a wafer or a semiconductor device may be determined to be defective.

The semiconductor device defect detecting apparatus 100 of FIG. 1A may further determine whether a wafer or semiconductor device is defective based on characteristics of a detected signal in a predetermined frequency range. For example, when an acoustic wave appears and disappears within 0.1 second and the wave is found within 20 kHz to 300 KHz, the wave may correspond to a burst acoustic emission. A burst acoustic emission, which is caused by a defect in the wafer or semiconductor device, is distinguishable from white noise in that it may be twice the amplitude of white noise.

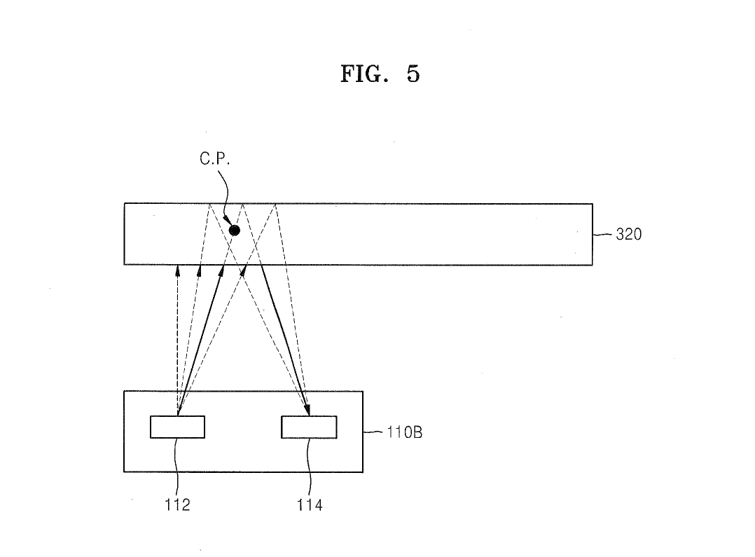

FIG. 5 is a diagram illustrating the use of ultrasonic waves in the semiconductor device defect detecting apparatus 100 of FIG. 1A to detect a defect of a semiconductor device, according to an exemplary embodiment of the inventive concept.

Referring to FIG. 5, an ultrasonic sensor 110B may include a transmitting device 112 and a receiving device 114. The transmitting device 112 may generate source waves and transmit the source waves to a semiconductor device 320 periodically by scanning the semiconductor device 320 on semiconductor process equipment. The source waves generated by the transmitting device 112 are usually ultrasonic waves, but are not limited thereto. For example, the source waves may be laser waves such as heat rays that are radiated to a semiconductor device so that the semiconductor device can generate ultrasonic waves.

The receiving device 114 may receive ultrasonic waves from the semiconductor device 320. When the semiconductor device 320 is normal, ultrasonic waves having somewhat uniform characteristics may be received. However, when a crack, a pore, or the like exists in the semiconductor device 320, some of the received ultrasonic waves that have passed a portion of the semiconductor device 320 having the crack, the pore, or the like, for example, a crack point C.P., may have different characteristics from the others. For example, the ultrasonic waves that have passed the crack point C.P. may have a greatly different wavelength than the other ultrasonic waves.

Accordingly, whether the semiconductor device 320 is defective may be determined by analyzing the received ultrasonic waves. When an AE sensor is used as described above with reference to FIG. 2, whether a semiconductor device is defective may be determined by detecting generated AE waves at the moment when cracking or pattern deformation occurs. On the other hand, when an ultrasonic sensor is used as in the present embodiment, whether a semiconductor device is defective may be determined, at the moment when cracking or pattern deformation occurs in the semiconductor device and after cracking or pattern deformation occurs in the semiconductor device.

When an ultrasonic sensor is used in a semiconductor device defect detecting apparatus as in the present embodiment, while a semiconductor process is being conducted on semiconductor process equipment, a transmitting device radiates source waves at intervals of a predetermined time and a receiving device receives and analyzes ultrasonic waves, thereby detecting a defect of a semiconductor device in real time during the semiconductor process. In addition, when an ultrasonic sensor is used in a semiconductor device defect detecting apparatus as in the present embodiment, since the ultrasonic sensor is able to detect a defect after the defect has been generated, a test based on the ultrasonic sensor may be performed after a corresponding process is completed, thereby adding another layer of defect detection of a semiconductor device.

For reference, detections based on an ultrasonic sensor may be classified as a vertical beam method and an angle beam method according to whether ultrasonic waves are vertically incident upon a surface to be probed or incident upon a surface to be probed at an arbitrary angle. The detections based on an ultrasonic sensor may also be classified as a single probe method and a multi-probe method according to whether a transmitting device and a receiving device are incorporated or separated. The detections based on an ultrasonic sensor may also be classified as A-Scope, B-Scope, and C-Scope according to methods of displaying a result of the detection on a screen.

Although the use of an AE sensor or an ultrasonic sensor in the semiconductor device defect detecting apparatus 100 of FIG. 1A has been illustrated above, a sensor used in the semiconductor device defect detecting apparatus 100 is not limited to an AE sensor and an ultrasonic sensor. In other words, all sensors capable of performing nondestructive testing on a semiconductor device or a wafer may be used in the semiconductor device defect detecting apparatus 100 of FIG. 1A. For example, sensors based on radiation may be used in the semiconductor device defect detecting apparatus 100.

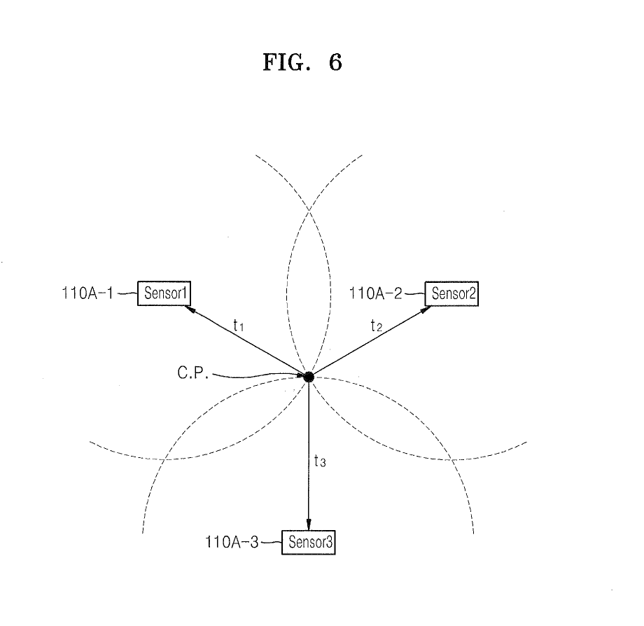

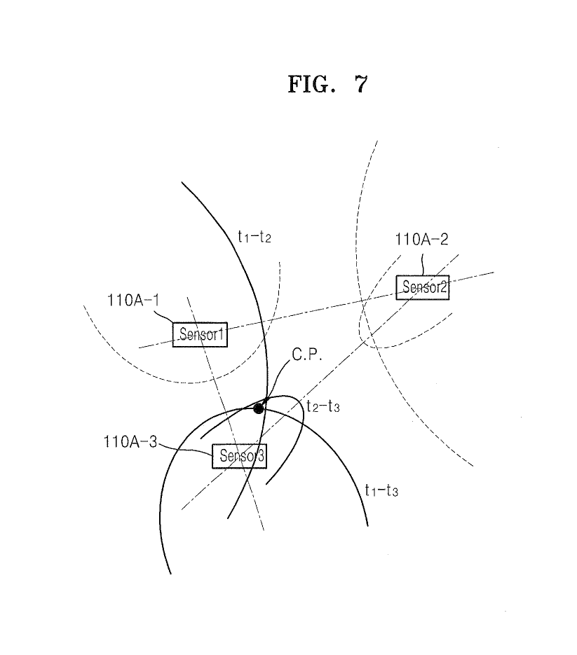

FIGS. 6 and 7 are diagrams illustrating principles by which a semiconductor device defect detecting apparatus according to an exemplary embodiment of the inventive concept detects a defect-generated location by using at least three AE sensors.

Referring to FIG. 6, three AE sensors, for example, first, second, and third AE sensors 110A-1, 110A-2, and 110A-3, may be installed on different portions of semiconductor process equipment. When a crack is generated in a semiconductor device on the semiconductor process equipment, AE waves may be generated from a crack point C.P., and the AE waves may be detected by each of the first, second, and third AE sensors 110A-1, 110A-2, and 110A-3. The first, second, and third AE sensors 110A-1, 110A-2, and 110A-3 may be spaced apart from the crack point C.P. by different distances. Accordingly, the first, second, and third AE sensors 110A-1, 110A-2, and 110A-3 may receive the AE waves at different points of time.

For example, when the point of time a crack is generated is set to be 0, the first AE sensor 110A-1 receives the AE waves after a period of time t1, the second AE sensor 110A-2 receives the AE waves after a period of time t2, and the third AE sensor 110A-3 receives the AE waves after a period of time t3. Assuming that AE sensors receive AE waves via an identical medium (for example, when a crack is generated on a surface of a wafer and AE waves generated due to the crack are transmitted via a chuck table attached to the wafer, the chuck table may serve as the identical medium), distances of the AE sensors from the crack point C.P. may be calculated based on AE wave receiving points of time, because the speeds of AE waves are identical when transmitted via an identical medium. Accordingly, circles that have distances corresponding to the AE wave receiving points of time as their radii may be drawn with the AE sensors as their centers, and an intersecting point of the three circles may be detected as the crack point C.P. In other words, due to installation of three AE sensors on semiconductor process equipment, generation or non-generation of a crack may be determined, and also a crack-generated location may be detected. A method of detecting a crack point by using an AE wave receiving point of time, for example, an AE arrival point of time, as described above is referred to as a Time of Arrival (ToA) based method.

Although the above description was given by setting the point of time a crack is generated to be 0, one may not know when the crack is actually generated. Accordingly, the receiving point of time, for example, a ToA, starting from the crack-generated point of time may not be accurately measured. To measure this, the following methods may be considered.

First, the point of time when a crack is generated during a semiconductor process may be somewhat predicted. For example, in the aforementioned tape mounting process, in most cases, a crack is generated in a wafer due to the weight of a hand when the wafer is loaded on a chuck table, or due to vacuum absorption. Accordingly, the crack-generated point of time may be determined by setting a point of time when a crack is frequently generated in a semiconductor device during a semiconductor process to be 0, and measuring a point of time when AE waves are detected by each AE sensor. For example, in a tape mounting process, a point of time when a wafer is loaded by a hand or a point of time when vacuum absorption is performed on the wafer is set to be 0, and a point of time when AE waves are detected by each AE sensor is measured.

The crack-generated point of time may also be determined by installing one more AE sensors on semiconductor process equipment and accordingly detecting AE waves with four AE sensors. For example, when AE waves are generated at a point of time t0, points of time when the four AE sensors receive the AE waves are points of time t1 through t4, and circles corresponding to periods of time t1−t0, t2−t0, t3−t0, and t4−t0 are drawn with the four AE sensors as their centers, the point of time t0 may be calculated, and, when the point of time t0 is calculated, the location of a crack may be automatically detected.

FIG. 7 illustrates a different crack-location detecting method from FIG. 6, but the method of FIG. 7 still uses three AE sensors, for example, first, second, and third sensors 110A-1, 110A-2, and 110A-3, like the method of FIG. 6.

Referring to FIG. 7, the first, second, and third sensors 110A-1, 110A-2, and 110A-3, respectively measure AE wave detection points of time. For example, a point of time measured by the first AE sensor 110A-1 is t1, a point of time measured by the second AE sensor 110A-2 is t2, and a point of time measured by the third AE sensor 110A-3 is t3. Here, the points of time t1, t2, and t3 are not periods of time taken for AE waves to move from a crack point C.P. to the three AE sensors, but points of time when the AE waves are simply detected, Thus, one may not know a point of time when a crack has been generated. Accordingly, a ToA method may not be used.

However, the location of the crack point C.P. may be determined using a difference between points of time when different AE sensors receive the AE waves. In other words, a difference between points of time when AE waves arrive at two AE sensors is proportional to a difference between distances from the two AE sensors to the crack point C.P. For example, a difference between points of time when AE waves arrive at the first and second AE sensors 110A-1 and 110A-2 is t1−t2, and the time difference t1−t2 corresponds to a difference between distances from the first and second AE sensors 110A-1 and 110A-2 to the crack point C.P. Accordingly, the crack point C.P. is positioned where the difference of the distances to the two AE sensors is a constant, for example, on a hyperbola where the difference of the distances to the two AE sensors is a constant.

Consequently, a difference of distances between every two AE sensors may be obtained using a difference between AE wave arrival points of time, a hyperbola where the difference of the distances between every two AE sensors is a constant may be drawn, and thus an intersection of the drawn hyperbolas may be determined as the crack point C.P. In FIG. 7, only intersecting curves in the hyperbolas are indicated by solid lines, and the other curves that do not intersect each other are indicated by dotted lines. A method of detecting a crack point by using a difference between AE arrival points of time as described above is referred to as a Time Difference of Arrival (TDoA) based method.

Although a method of detecting the location of a crack generated in a semiconductor device by using at least three AE sensors has been described above, the crack location may also be detected according to the same principle even when other types of sensors are used. When an ultrasonic sensor is used, for example, a transmitting device radiates ultrasonic waves to a semiconductor device by scanning the semiconductor device at a predetermined angle and at predetermined intervals, a receiving device receives the ultrasonic waves, and paths of the normally received ultrasonic waves are calculated. Accordingly, when the receiving device receives ultrasonic waves corresponding to cracking or pattern deformation, a portion of the semiconductor device in which the cracking or the pattern deformation has occurred may be detected by comparing the calculated paths of abnormally received ultrasonic waves to the pre-calculated paths of normally received ultrasonic waves.

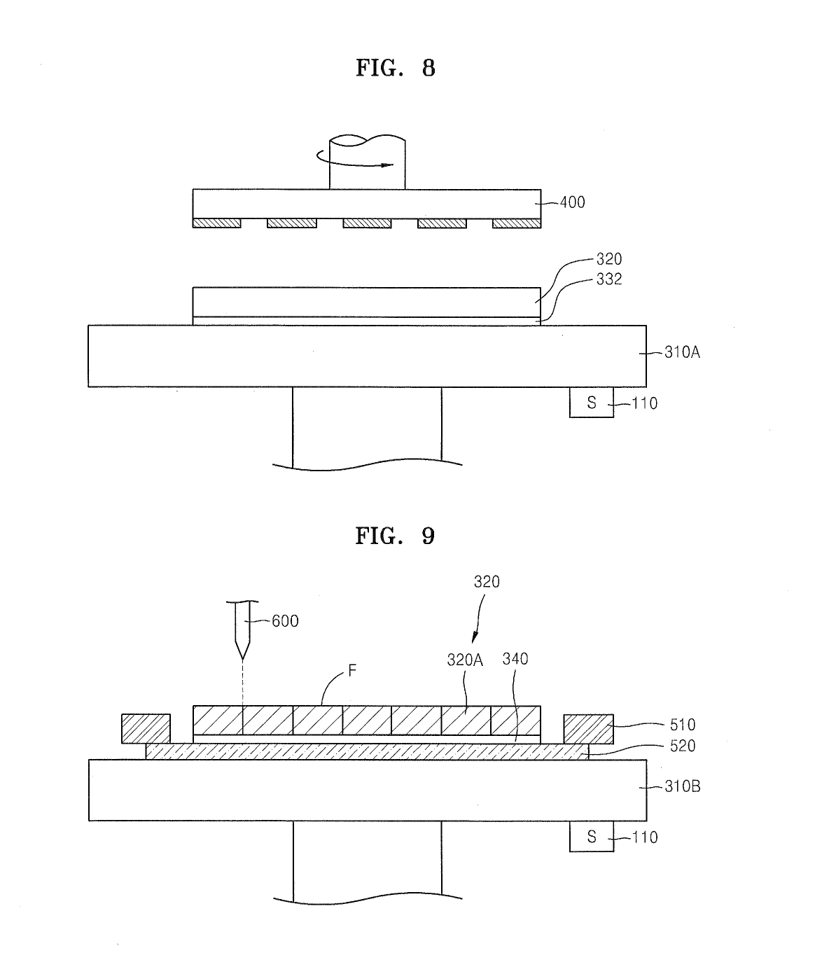

FIGS. 8 through 11 are cross-sectional views of semiconductor process equipment that may use the semiconductor device defect detecting apparatus 100 of FIG. 1A, and sensors mounted on the semiconductor process equipment, according to exemplary embodiments of the inventive concept.

FIG. 8 depicts B/L equipment, and a B/L process performed by the B/L equipment is a process of polishing a back surface of a wafer to reduce the thickness of the wafer, after forming integrated circuits on the wafer.

Referring to FIG. 8, the B/L equipment may include a chuck table 310A for supporting a wafer 320, and a polisher 400 for polishing a back surface of the wafer 320. A protective tape 332 for protecting integrated circuits may be attached to an upper surface of the wafer 320, for example, an active surface having integrated circuits formed thereon. After a B/L process is performed by the B/L equipment, the wafer 320 may be thinned to about 100 μm or less.

In the B/L process, when the wafer 320 is loaded onto the chuck table 310A and when the wafer 320 is polished, cracking or pattern deformation may occur in the wafer 320. Accordingly, the semiconductor device defect detecting apparatus 100 of FIG. 1A may be used to detect this cracking or pattern deformation in real time. For example, the sensor 110 of the semiconductor device defect detecting apparatus 100 may be installed on the chuck table 310A of the B/L equipment and may detect cracking or pattern deformation of the wafer 320 during the B/L process.

FIG. 9 depicts die sawing equipment, and a die sawing process performed by the die sawing equipment is a process of separating dies of a wafer from one another by using a blade, laser, or the like after a tape mounting process is performed on a wafer on which the B/L process has already been performed.

Referring to FIG. 9, the die sawing equipment may include a chuck table 310B for supporting a wafer 320, and a blade 600 for dividing the wafer 320 into dies 320A.

The wafer 320 is attached to a tape 520, which has a ring mount 510 disposed on its circumference, and is loaded onto the chuck table 310B. The tape 520 is also referred to as an extension tape because of its function. A die attach film (DAF) 340 may be attached to a bottom surface of the wafer 320. In some cases, the DAF 340 may not be included.

For reference, in the tape mounting process described above with reference to FIG. 3, 4A or 4B, the wafer 320 is loaded onto the chuck table 310, and a tape inside a ring mount is attached to a back surface of the wafer 320. However, in general, a DAF is first attached to the back surface of a wafer and then a tape inside a ring mount is attached to the DAF. Referring to FIG. 9, after the tape mounting process is performed on the wafer 320, the wafer 320 is upside down while being loaded onto the chuck table 310B of the die sawing equipment so that an upper surface F of the wafer 320 faces up. After the wafer 320 attached to the tape 520 is loaded onto the chuck table 310B of the die sawing equipment, the die sawing process is performed using the blade 600. The die sawing process may be performed using a laser instead of the blade 600. Cracking or pattern deformation may occur in the wafer 320 during this die sawing process. Accordingly, the semiconductor device defect detecting apparatus 100 of FIG. 1A may be used to detect in real time this cracking or pattern deformation occurring in the wafer 320 during the die sawing process. For example, the sensor 110 of the semiconductor device defect detecting apparatus 100 may be installed on the chuck table 310B of the die sawing equipment and may detect cracking or pattern deformation of the wafer 320 during the die sawing process.

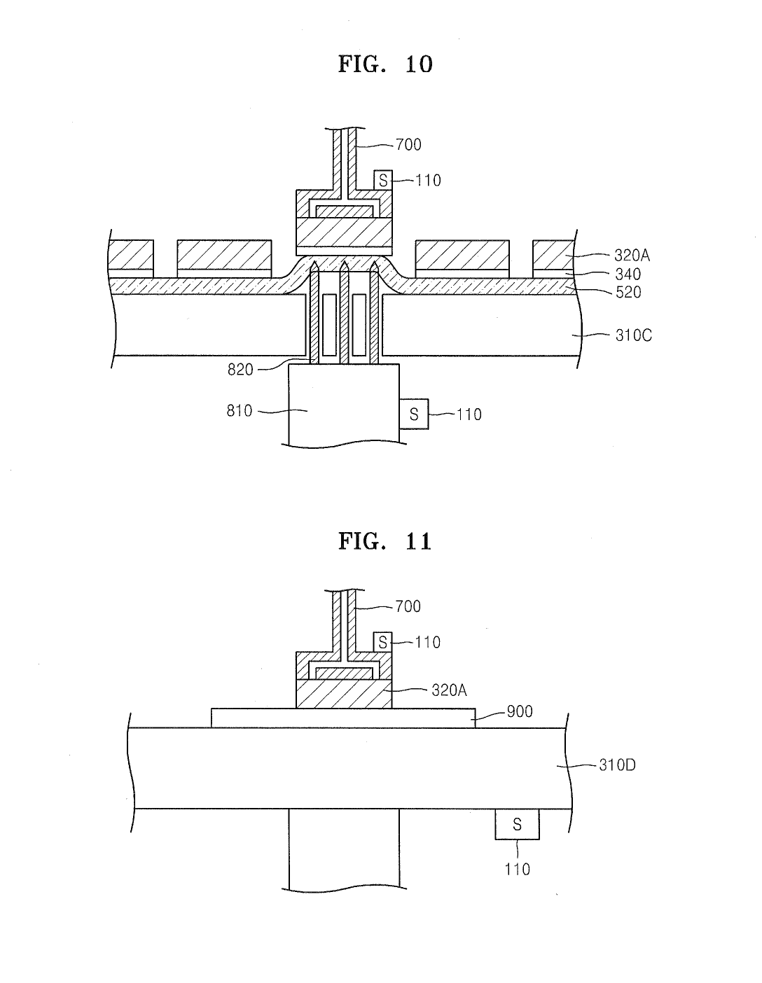

FIG. 10 depicts die attach (D/A) equipment, in particular, equipment for picking up dies 320A separated after a die sawing process. A DAF 340 is attached to the separated dies 320A.

Referring to FIG. 10, after a die sawing process, a wafer is divided into the dies 320A. Thereafter, pins 820 included in a pin holder 810 below a chuck table 310C push upward both the tape 520 and each die 320A, and a collet 700 picks up the protruding die 320A via vacuum absorption. In this way, each die 320A to which the DAF 340 has been attached may be picked-up.

During this die picking-up process, cracking or pattern deformation may occur in each die 320A. For example, when the pins 820 push the die 320A up, when the collet 700 picks up the die 320A via vacuum absorption, or when a foreign material is attached to the collet 700, a physical impact may be applied to the die 320A, and thus cracking or pattern deformation may occur in the die 320A. In addition, when a die is attached to a printed circuit board (PCB), which may be a half-completed product, as will be described below with reference to FIG. 11, cracking or pattern deformation may occur in the die. Moreover, when another die is attached to the die on the PCB or when another die is attached to the die stained with the foreign material, cracking or pattern deformation may occur in these dies.

The semiconductor device defect detecting apparatus 100 of FIG. 1A may be used to detect in real time cracking or pattern deformation occurring in the die 320A during a die picking-up process. For example, the sensor 110 of the semiconductor device defect detecting apparatus 100 may be installed on the collet 700 and/or the pin holder 810 and may detect cracking or pattern deformation of the die 320A during a die picking-up process.

FIG. 11 depicts D/A equipment, in particular, equipment for attaching a picked-up die 320A to each PCB 900.

Referring to FIG. 11, the PCB 900 is disposed on a heater block 310D, and a die 320A picked up by the collet 700 may be attached to the PCB 900. The heater block 310D may support the PCB 900, which is a sort of a chuck table, while heating the PCB 900 to about 150° C. so that a die may be easily attached to the PCB 900. A temperature used by the heater block 310D to heat the PCB 900 is not limited thereto.

During this D/A process, cracking or pattern deformation may occur in each die 320A. Accordingly, the semiconductor device defect detecting apparatus 100 of FIG. 1A may be used to detect in real time this cracking or pattern deformation occurring in each die 320A during the D/A process. For example, the sensor 110 of the semiconductor device defect detecting apparatus 100 may be installed on the collet 700 and/or the heater block 310D and may detect cracking or pattern deformation of the die 320A during a D/A process.

The semiconductor process equipment to which the semiconductor device defect detecting apparatus 100 of FIG. 1A is applicable have been briefly described with reference to FIGS. 8 through 11. However, semiconductor process equipment capable of using the semiconductor device defect detecting apparatus 100 are not limited thereto. For example, the semiconductor device defect detecting apparatus 100 may be applied to all semiconductor process equipment that may cause cracking or pattern deformation to occur in a semiconductor device or a wafer.

For example, a semiconductor device defect detecting apparatus according to an exemplary embodiment of the inventive concept may be applied to all of the big eight semiconductor processes, for example, Etch, Metal, Clean, Imp, Diff, Photo, chemical vapor deposition (CVD), and chemical mechanical polishing (CMP) processes. For example, the semiconductor device defect detecting apparatus 100 of FIG. 1A may be applied to chuck tables for supporting a wafer or a semiconductor device, such as an electrostatic chuck used in a CVD process or an etch process and a vacuum chuck used in photolithography, or to devices that physically contact a wafer or a semiconductor device and move the same to these chuck tables, to detect a defect in real time.

In more detail, devices that physically contact a semiconductor device during a semiconductor process and apply a physical force, such as a compressive force or a tensile force, to the semiconductor device may cause cracking or pattern deformation to occur in the semiconductor device. For example, a chuck table, a collet, and the like in which vacuum absorption is performed may cause cracking or pattern deformation in a semiconductor device. In a polishing process, an attaching process, and the like, cracking or pattern deformation may occur in a semiconductor device. Accordingly, the semiconductor device defect detecting apparatus 100 of FIG. 1A may be applied to all devices that physically contact a semiconductor device or a wafer and apply a force to the semiconductor device or the wafer. In other words, a sensor of the semiconductor device defect detecting apparatus 100 may be attached to these devices, and thus a defect of a semiconductor device may be detected in real time during a semiconductor process.

In addition, a semiconductor device may have a crack or a pattern deformation due to a temperature variation, an external impact, or the like while the semiconductor device is in storage or in motion. Accordingly, the semiconductor device defect detecting apparatus 100 of FIG. 1A may also be applied to devices that store semiconductor devices or devices that transfer semiconductor devices. Moreover, since cracking or pattern deformation of a semiconductor device may also occur in an evaluation process, the semiconductor device defect detecting apparatus 100 may also be applied to equipment for use in an evaluation process.

The semiconductor device defect detecting apparatus 100 of FIG. 1A is not limited to the detection of cracking or pattern deformation in a semiconductor device. For example, the semiconductor device defect detecting apparatus 100 may be applied to detect cracking or pattern deformation in process equipment.

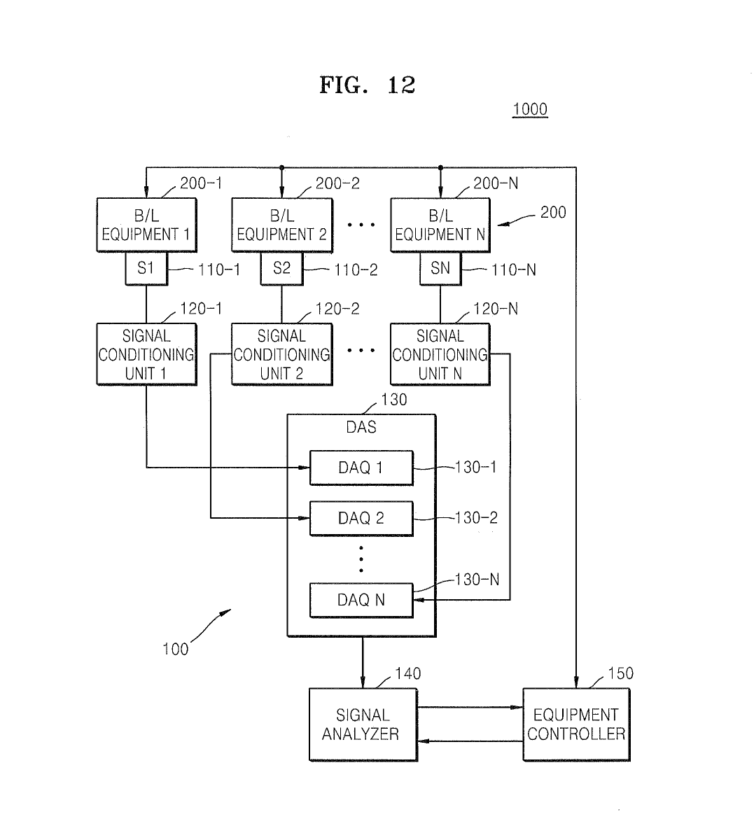

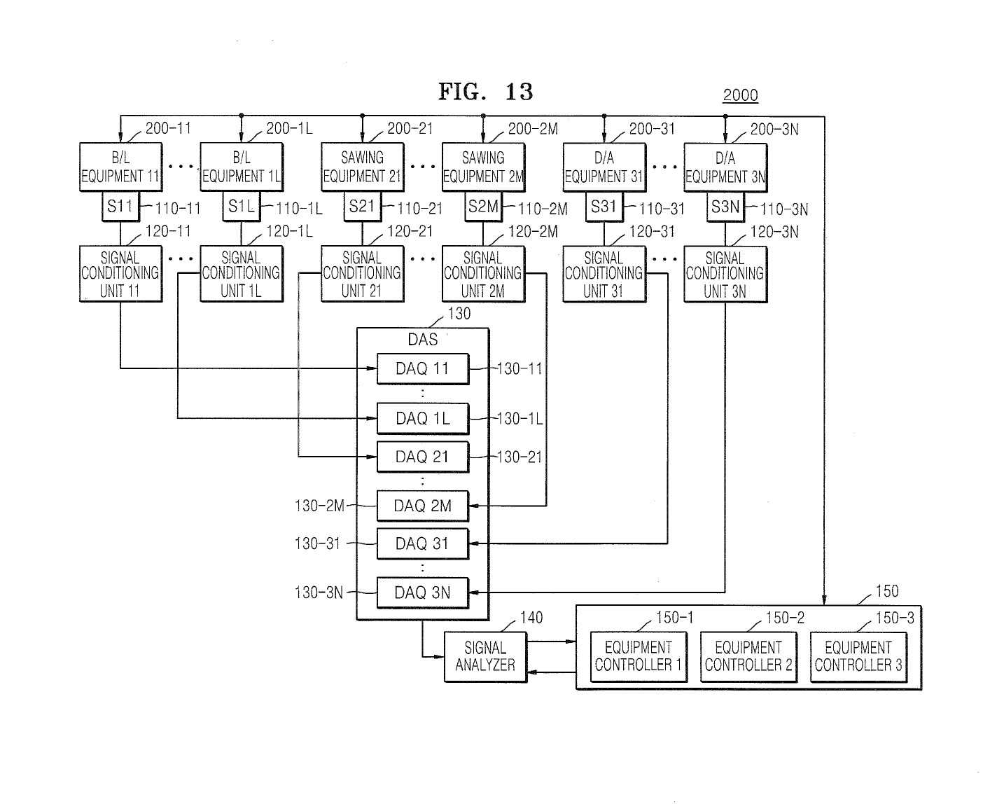

FIGS. 12 and 13 are block diagrams of semiconductor manufacturing systems 1000 and 2000 including a semiconductor device defect detecting apparatus, according to exemplary embodiments of the inventive concept.

Referring to FIG. 12, the semiconductor manufacturing system 1000 may include the semiconductor device defect detecting apparatus 100, the equipment controller 150, and the semiconductor process equipment 200.

The semiconductor process equipment 200 may include a plurality of equipment. For example, the semiconductor process equipment 200 may include N B/L equipment 200-1, 200-2, . . . , and 200-N. The semiconductor process equipment 200 is not limited to B/L equipment. For example, all equipment types used in a semiconductor process, such as die attaching equipment, die sawing equipment, and the like may be included in the semiconductor process equipment 200. Depending on what equipment is included in the semiconductor process equipment 200, the semiconductor manufacturing system 1000 may be classified as a semiconductor device producing system, a semiconductor device transferring system, a semiconductor device evaluating system, or the like.

As the semiconductor process equipment 200 includes the N B/L equipment 200-1, 200-2, . . . , and 200-N, the semiconductor device defect detecting apparatus 100 may include N sensors 110-1, 110-2, . . . , and 110-N, N signal conditioning units 120-1, 120-2, . . . , and 120-N, the signal converter 130, and the signal analyzer 140.

The N sensors 110-1, 110-2, . . . , and 110-N may be attached to the N B/L equipment 200-1, 200-2, . . . , and 200-N, respectively. For example, the N sensors 110-1, 110-2, . . . , and 110-N may be attached to respective chuck tables of the N B/L equipment 200-1, 200-2, . . . , and 200-N, respectively. The N sensors 110-1, 110-2, . . . , and 110-N may detect signals generated from wafers on the N B/L equipment 200-1, 200-2, . . . , and 200-N, respectively.

When the location of cracking or pattern deformation occurring in a wafer is to be detected, at least three sensors may be attached to each of the N B/L equipment 200-1, 200-2, . . . , and 200-N. The N sensors 110-1, 110-2, . . . , and 110-N may be any sort of sensors capable of performing non-destructive testing as described above. For example, the N sensors 110-1, 110-2, . . . , and 110-N may be AE sensors or ultrasonic sensors.

The N signal conditioning units 120-1, 120-2, . . . , and 120-N may be connected to the N sensors 110-1, 110-2, . . . , and 110-N, respectively, via cables to receive signals from the N sensors 110-1, 110-2, . . . , and 110-N. The N signal conditioning units 120-1, 120-2, . . . , and 120-N may receive signals from the N sensors 110-1, 110-2, . . . , and 110-N wirelessly. Each of the N signal conditioning units 120-1, 120-2, . . . , and 120-N may perform noise removal and/or amplification on a signal received from a corresponding sensor, as described above with reference to FIG. 1B. When the N sensors 110-1, 110-2, . . . , and 110-N include respective signal conditioning units built therein, the N sensors 110-1, 110-2, . . . , and 110-N may be directly connected to DAQ modules 130-1, 130-2, . . . , and 130-N, respectively.

The signal converter 130 may include the N DAQ modules 130-1, 130-2, . . . , and 130-N. The N DAQ modules 130-1, 130-2, . . . , and 130-N receive signals from the N signal conditioning units 120-1, 120-2, . . . , and 120-N, respectively, and convert the received signals into digital signals suitable for analysis. Other types of modules including a DAC device may be used instead of a DAQ module. The signal converter 130 may be referred to as a data acquisition system (DAS) because it includes a plurality of DAQ modules.

The signal analyzer 140 may store the digital signals output by the signal converter 130 as raw-data in a storage medium, and may determine whether a semiconductor device is defective, by analyzing the raw-data according to a predetermined rule. For example, in the case of B/L equipment, the existence or non-existence of AE waves in a wafer loading process section is determined, it is also determined whether a voltage level of the AE waves exceeds a set threshold voltage and whether a calculated energy exceeds a set threshold energy, and it is further determined whether the AE waves correspond to a signal having a predetermined cycle when the AE waves exceed the set threshold voltage and the set threshold energy, thereby determining whether a wafer is defective or not.

When the signal analyzer 140 determines whether the semiconductor device is defective, the equipment controller 150 may receive a signal corresponding to a result of the determination performed by the signal analyzer 140 and may interrupt an operation of a B/L equipment that incurs a defect, according to a control signal for controlling equipment. After the operation of the corresponding B/L equipment is interrupted, a defect incurring factor is removed from the B/L equipment to resume the operation of the B/L equipment.

For reference, although the equipment controller 150 is included in the semiconductor device defect detecting apparatus 100 in FIG. 1A, it is separate from the semiconductor device defect detecting apparatus 100 in the present embodiment. However, this is only an explanatory difference, and thus, as long as the equipment controller 150 controls an operation of semiconductor process equipment according to a result of the determination performed by the signal analyzer 140, it does not matter whether the equipment controller 150 is included in the semiconductor device defect detecting apparatus 100 or included as a separate component in the semiconductor manufacturing system 1000.

In addition, the equipment controller 150 may not only control an operation of the semiconductor process equipment according to the result of the determination performed by the signal analyzer 140 but also may control an operation of the semiconductor process equipment in cooperation with devices other than the semiconductor device defect detecting apparatus 100. Accordingly, the equipment controller 150 may perform a function of a communication control server that controls the entire operation of the semiconductor process equipment in response to commands issued from several places. Although not shown in FIG. 12, a PC may be included in each of the semiconductor process equipment, for example, each of the N B/L equipment 200-1, 200-2, . . . , and 200-N, and thus may communicate with the equipment controller 150 when a defect is generated in the corresponding B/L equipment. For example, when a defect is generated in the B/L equipment 200-1, the PC included in the B/L equipment 200-1 sends a signal to the equipment controller 150, and the equipment controller 150 analyzes the signal and thus may interrupt an operation of the B/L equipment 200-1.

Referring to FIG. 13, the semiconductor manufacturing system 2000 is the same as the semiconductor manufacturing system 1000 of FIG. 12 except that different semiconductor process equipment is shown. In other words, the semiconductor process equipment included in the semiconductor manufacturing system 1000 of FIG. 12 is of a single type. For example, equipment used in a single process from among a plurality of B/L equipment, a plurality of sawing equipment, a plurality of die attaching equipment, and the like are included in the semiconductor manufacturing system 1000 of FIG. 12. However, the semiconductor manufacturing system 2000 according to the present embodiment may include all sorts of semiconductor process equipment that may incur cracking or pattern deformation in a semiconductor device.

For example, the semiconductor process equipment 200 of the semiconductor manufacturing system 2000 may include L B/L equipment 200-11, . . . , and 200-1L, M sawing equipment 200-21, . . . , and 200-2M, and N die attaching equipment 200-31, . . . , and 200-3N. The semiconductor process equipment 200 is not limited to B/L equipment, sawing equipment, and die attaching equipment, and all sorts of equipment that may incur cracking or pattern deformation in a semiconductor device during a semiconductor process may be included in the semiconductor process equipment 200. Accordingly, the semiconductor manufacturing system 2000 according to the present embodiment may denote a comprehensive semiconductor process system including all of production, transportation, and evaluation of a semiconductor device.

As the semiconductor process equipment 200 includes the L B/L equipment 200-11, . . . , and 200-1L, the M sawing equipment 200-21, . . . , and 200-2M, and the N die attaching equipment 200-31, . . . , and 200-3N, a number of sensors (110-11 . . . 110-1L, 110-21 . . . 110-2M and 110-31 . . . 110-3N), a number of signal conditioning units (120-11 . . . 120-1L, 120-21 . . . 120-2M and 120-31 . . . 120-3N), and a number of DAQ modules (130-11 . . . 130-1L, 130-21 . . . 130-2M and 130-31 . . . 130-3N) equal to the number of B/L equipment, M sawing equipment, and N die attaching equipment may be included. When the location of the cracking or the pattern deformation is to be detected, at least three sensors may be attached to each sort of equipment, as described above.

The equipment controller 150 may include a first equipment controller 150-1, a second equipment controller 150-2, and a third equipment controller 150-3 corresponding to the three types of equipment, respectively. For example, the first equipment controller 150-1 may control operations of the L B/L equipment 200-11, . . . , and 200-1L, the second equipment controller 150-2 may control operations of the M sawing equipment 200-21, . . . , and 200-2M, and the third equipment controller 150-3 may control operations of the N die attaching equipment 200-31, . . . , and 200-3N. When the equipment controller 150 receives a result of the determination performed by the signal analyzer 140, the first to third equipment controllers 150-1, 150-2 and 150-3 may control maintenance or interruption of operations of their corresponding equipment. The equipment controller 150 may not be divided into 3 devices as shown in FIG. 13 and may be implemented using a single device.

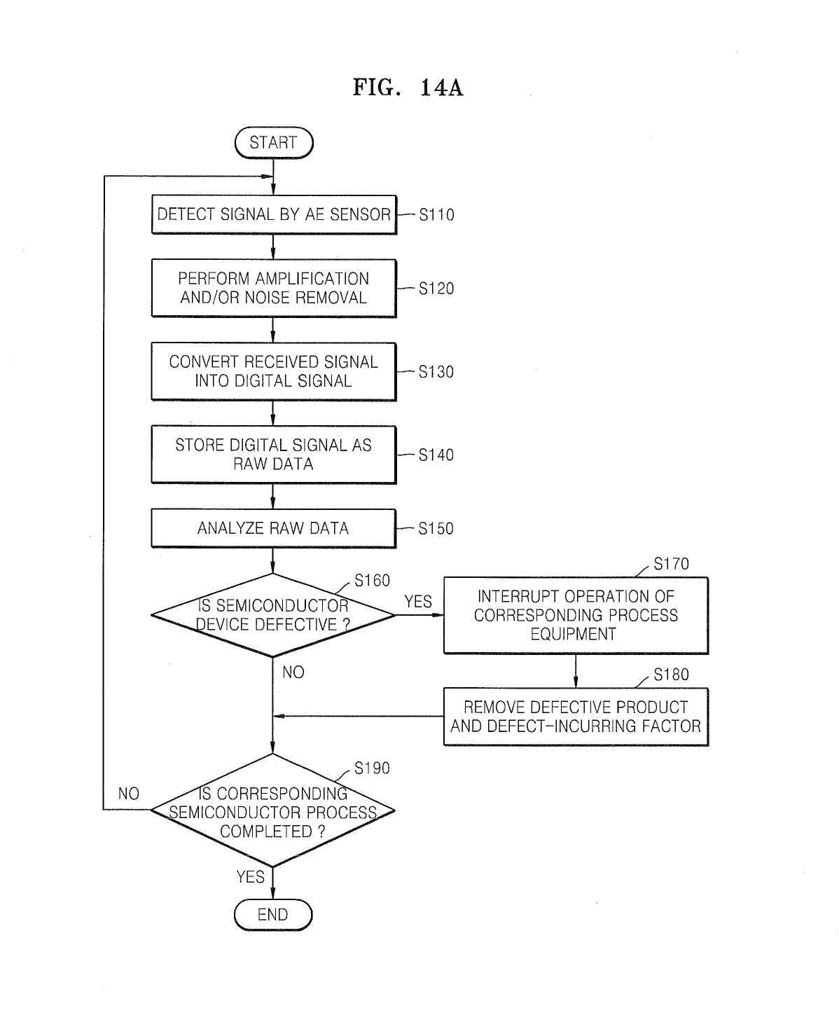

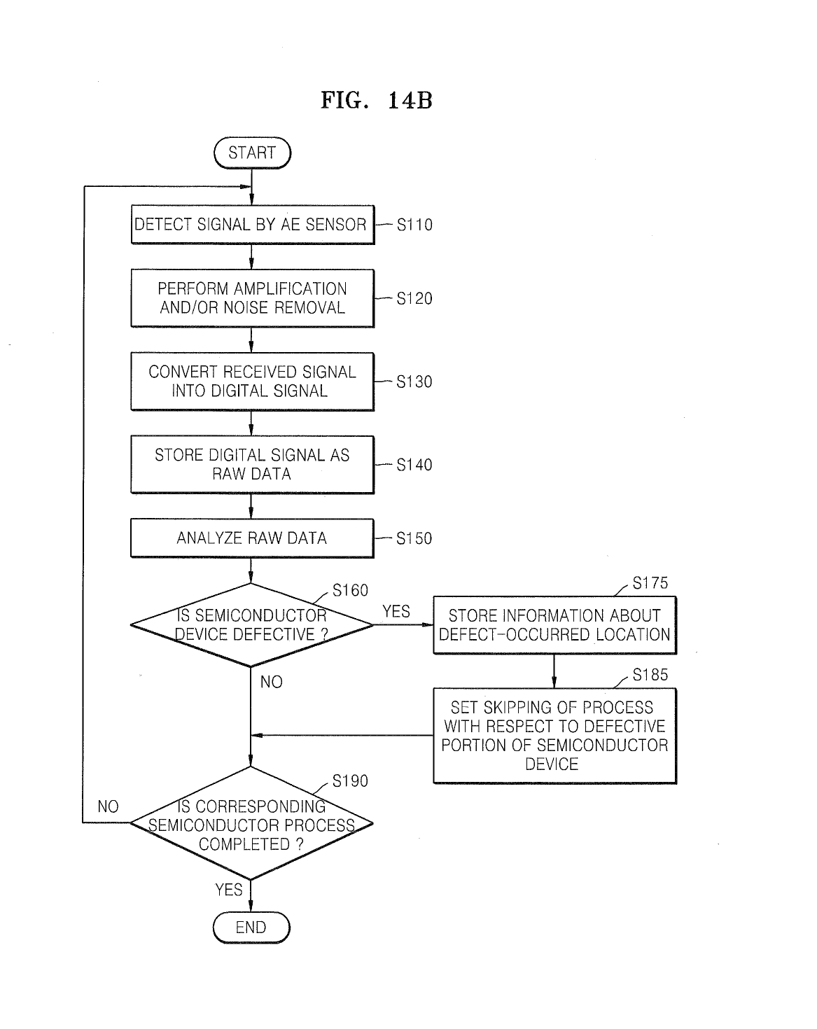

FIGS. 14A and 14B are flowcharts of semiconductor device defect detecting methods that use an AE sensor, according to exemplary embodiments of the inventive concept. For convenience of explanation, the semiconductor device defect detecting methods will now be described with reference to FIGS. 14A and 14B together with FIG. 3.

Referring to FIG. 14A, first, a signal, for example, AE waves, is detected by the AE sensor 110A, in operation S110. For example, in a tape mounting process, when the wafer 320 is loaded from the hand 330 onto the chuck table 310, hand weight application and vacuum absorption are conducted, AE waves are generated when a crack is generated in the wafer 320 due to the existence of a foreign material such as particles on the chuck table 310, and the AE waves may be detected by the AE sensor 110A.

Next, the signal conditioning unit 120 receives a signal from the AE sensor 110A and performs amplification and/or noise removal on the received signal, in operation S120. As described above with reference to FIG. 1B, the signal conditioning unit 120 may include the pre-amplifier 122, the filter 124, and the amplifier 126 to perform the amplification and/or the noise removal on the received signal.

After signal conditioning is performed in the signal conditioning unit 120, a signal output by the signal conditioning unit 120 is converted into a digital signal suitable for analysis by the signal converter 130, for example, a DAQ module, in operation S130. Although a DAQ module is mentioned as the signal converter 130, other modules including a DAC device may be used as the signal converter 130.

In operation S140, the digital signal output by the signal converter 130 is stored as raw-data in a storage medium by the signal analyzer 140. In some cases, the operation S140 may not be included.

In operation S150, the signal analyzer 140 reads the raw-data from the storage medium and analyzes the raw-data according to a predetermined rule. For example, the raw-data may be analyzed in units of process sections, and it may be determined whether an abrupt AE wave exists in a set process section. If the digital signal output by the signal converter 130 is not stored as raw-data, the digital signal may be analyzed right after being received from the signal converter 130. A result of the analysis may be stored as analysis data in the storage medium. In more detail, when a semiconductor process performed with respect to each wafer, for example, a tape mounting process, is completed, a result of the analysis performed on each wafer may be stored as the analysis data in the storage medium. The analysis data stored may be used for later determination of process sections, setting of a threshold voltage, a threshold energy, a specific frequency, and the like.

In operation S160, the signal analyzer 140 determines whether the semiconductor device is defective, based on the result of the analysis. For example, when abrupt AE waves are detected in a set process section, the voltage level of the AE waves is compared with a set threshold voltage, a calculated energy is compared with a set threshold energy, and, when the AE waves exceed the set threshold voltage and the set threshold energy, it is determined whether the AE waves correspond to a signal having a predetermined cycle, and if they do, the semiconductor device is defective. When at least three sensors are installed, the signal analyzer 140 may detect a location of cracking or pattern deformation in a semiconductor device according to that described above with reference to FIG. 6 or 7.

When the semiconductor device is determined to be defective, the equipment controller 150 receives a signal corresponding to the result of the determination from the signal analyzer 140 and interrupts an operation of corresponding process equipment that has incurred the defect, according to a control signal for controlling semiconductor process equipment, in operation S170.

In operation S180, the defective product is removed, and a defect incurring factor is removed from the corresponding process equipment. For example, when a defect is generated due to silicon particles on a chuck table during a tape mounting process, the silicon particles are removed from the chuck table.

On the other hand, when the semiconductor device is not determined to be defective or after the operation S180, it is determined whether a corresponding semiconductor process is completed, in operation S190. For example, when the corresponding semiconductor process is a tape mounting process, completion or non-completion of the tape mounting process may be determined according to whether a tape mounted wafer is a final wafer. When the corresponding semiconductor process is completed, the semiconductor device defect detecting method is concluded. On the other hand, when the corresponding semiconductor process is not completed, the method may go back to the operation S110 and resume.

Referring to FIG. 14B, the semiconductor device defect detecting method according to the present embodiment is almost the same as that of FIG. 14A except for a measure taken when a semiconductor device is determined to be defective. In other words, although a defect incurring factor is removed by interrupting an operation of corresponding process equipment in FIG. 14A, the operation of the corresponding process equipment may not be interrupted in the present embodiment.

In more detail, when the semiconductor device is determined to be defective, information about a defect occurred location is stored, in operation S175. For example, information about a location of a die where a defect has occurred in a die attaching process is stored. Next, in operation S185, a semiconductor device manufacturing method is set so that a process which was to be performed on the semiconductor device at the location where the defect has occurred is skipped. For example, in a die attaching process, the semiconductor device manufacturing method is set so that a subsequent process, such as a picking-up process with respect to a die where the defect has occurred, is skipped.

Subsequent processes are the same as those of the semiconductor device defect detecting method of FIG. 14A. In other words, when the semiconductor device is not determined to be defective or after the operation S185, it is determined whether a corresponding semiconductor process is completed, in operation S190.

Although the operation S185 is followed by the operation S190 in FIG. 14B, the operation S185 may be performed separate from the corresponding semiconductor process. In other words, the corresponding semiconductor process progresses by performing the operation S190 after the operation S175, and, when skip setting is completed, the skip setting may be applied to the corresponding semiconductor process.

When an operation of the entire corresponding process equipment is interrupted even when a defect is generated in one or two dies of a wafer, this may degrade process yield compared to when a corresponding semiconductor process progress without interruptions. In the semiconductor device defect detecting method according to the present embodiment, when defect detection on each die is performed, a process to be performed with respect to a die having a defect is skipped by storing only information about a defect-occurred location, thereby improving process yield. Consequently, the semiconductor device defect detecting method of FIG. 14A or 14B may be applied to a corresponding semiconductor process depending on whether a defect detection target is a wafer or an individual die.

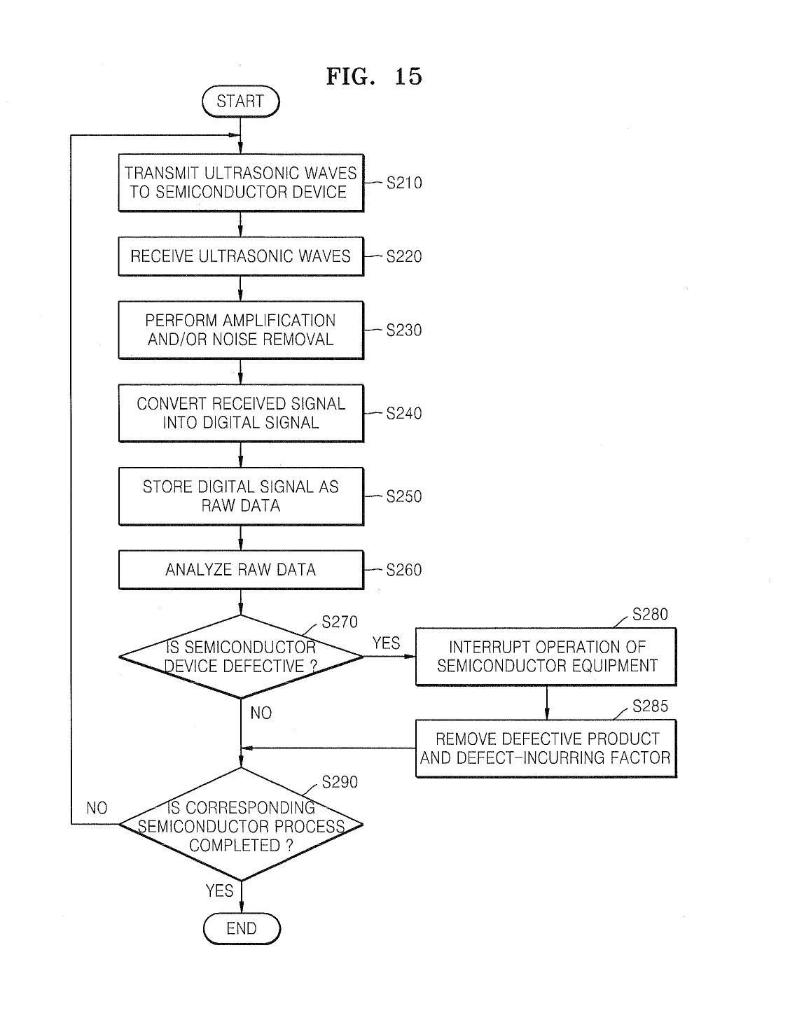

FIG. 15 is a flowchart of a semiconductor device defect detecting method that uses an ultrasonic sensor, according to an exemplary embodiment of the inventive concept. For convenience of explanation, the semiconductor device defect detecting method will now be described with reference to FIG. 15 together with FIGS. 3 and 5.

Referring to FIG. 15, first, the transmitting device 112 generates ultrasonic waves and transmits the ultrasonic waves to the semiconductor device 320, in operation S210. The transmitting device 112 may also generate, instead of the ultrasonic waves, source waves that allow the receiving device 114 to receive ultrasonic waves from the semiconductor device 320. The transmitting device 112 may transmit the ultrasonic waves periodically by scanning the entire surface of the semiconductor device 320, as described above with reference to FIG. 5.

Next, in operation S220, the receiving device 114 receives ultrasonic waves reflected or generated by the semiconductor device 320. The receiving device 114 may receive ultrasonic waves sequentially according to ultrasonic waves sequentially transmitted by the transmitting device 112.

Processes subsequent to the reception of ultrasonic waves by the receiving device 114 are similar to those subsequent to the AE wave reception of FIG. 14A except that the ultrasonic waves are analyzed in a different way from that in which AE waves are analyzed. For example, in the semiconductor device defect detecting method according to the present embodiment, the operation S220 in which the receiving device 114 receives ultrasonic waves is sequentially followed by an amplification and/or noise removal operation S230, a digital signal conversion operation S240, an operation S250 of storing a digital signal as raw-data, and a raw-data analysis operation S260. In the raw-data analysis operation S260, it may be determined whether a semiconductor device is defective according to the following principle.

The sequentially transmitted ultrasonic waves travel along respective preset paths of a semiconductor device, are reflected by the semiconductor device, and are received by the receiving device. If a defect such as cracking or pattern deformation does not occur in the semiconductor device, the received ultrasonic waves may have similar characteristics. For example, the wavelengths of the ultrasonic waves may be similar to each other. On the other hand, when a defect such as cracking or pattern deformation occurs in the semiconductor device, ultrasonic waves received via a portion of the semiconductor device having the cracking or the pattern deformation may have different characteristics from ultrasonic waves received via a normal portion of the semiconductor device. For example, the wavelength of the ultrasonic waves received via the portion of the semiconductor device having the cracking or the pattern deformation may be greatly different from that of the ultrasonic waves received via the normal portion of the semiconductor device. Accordingly, it may be determined whether the semiconductor device is defective, by analyzing the characteristics of the received ultrasonic waves.

A semiconductor device damage/non-damage determination operation S270, a semiconductor equipment interruption operation S280, a defect incurring factor removal and defective product removal operation S285, and a process conclusion/non-conclusion determination operation S290 after the raw-data analysis operation S260 may be similar to those of the semiconductor device defect detecting method of FIG. 14A. However, in the semiconductor device damage/non-damage determination operation S270, criteria based on the characteristics of the received ultrasonic waves instead of a threshold voltage, a threshold energy, and a predetermined frequency range may be used as a criterion for determining whether the semiconductor device is defective. For example, a threshold wavelength may be used.

The semiconductor device defect detecting method based on an ultrasonic sensor according to the present embodiment may be the same as the semiconductor device defect detecting method of FIG. 14A in terms of a measure taken when a semiconductor device is determined to be defective. However, a measure such as the measure of FIG. 14B is not excluded. For example, the measure of FIG. 14A (e.g., process interrupt) or 14B (e.g., skip) may be applied to the semiconductor device defect detecting method according to the present embodiment, depending on whether a defect detection target is a wafer or an individual die.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A semiconductor device defect detecting apparatus, comprising:
a sensor disposed on semiconductor process equipment, the sensor configured to detect a signal emitted from a semiconductor device in contact with the semiconductor process equipment; and
a signal analyzer configured to determine whether the semiconductor device is defective based on the detected signal in a predetermined frequency range.

2. The apparatus of claim 1, wherein the sensor is an acoustic emission sensor.

3. The apparatus of claim 1, wherein the predetermined frequency range is from 20 kHz to 300 kHz.

4. The apparatus of claim 1, wherein the semiconductor device is determined to be defective when a time range between appearance and disappearance of the detected signal is within 0.1 second in the predetermined frequency range.

5. The apparatus of claim 1, wherein the semiconductor device is determined to be defective when a threshold voltage of the detected signal or a threshold energy of the detected signal is exceeded in the predetermined frequency range.

6. The apparatus of claim 1, wherein the signal is emitted from the semiconductor device when the semiconductor device is processed by the semiconductor process equipment.

7. The apparatus of claim 1, further comprising: a controller configured to stop the semiconductor process equipment when the semiconductor device is determined to be defective.

8. A semiconductor device defect detecting apparatus, comprising:
a sensor disposed on a chuck table of semiconductor process equipment, the sensor configured to detect a signal emitted from a semiconductor device in contact with the chuck table; and
a signal analyzer configured to analyze the detected signal to determine whether the semiconductor device is defective by using a predetermined criteria.

9. The apparatus of claim 8, wherein the sensor is an acoustic emission sensor.

10. The apparatus of claim 8, wherein the chuck table is metal or ceramic.

11. The apparatus of claim 8, wherein the predetermined criteria include a threshold voltage of acoustic waves, a threshold energy of the acoustic waves and a frequency range of the acoustic waves, wherein the semiconductor device is determined to be defective when a threshold voltage of the detected signal and a threshold energy of the detected signal are exceeded in a predetermined frequency range.

12. The apparatus of claim 8, further comprising: a controller configured to stop the semiconductor process equipment when the semiconductor device is determined to be defective.

13. A method for detecting a defect in a semiconductor device, comprising:
detecting, in real-time, a signal emitted from a semiconductor device being processed by and in contact with semiconductor process equipment, wherein the detecting is performed by a sensor disposed on the semiconductor process equipment; and
determining, whether the semiconductor device is defective based on the detected signal in a predetermined frequency range, wherein the determining is performed by a signal analyzer.

14. The method of claim 13, wherein the sensor is an acoustic emission sensor.

15. The method of claim 13, wherein the semiconductor device is determined to be defective when a threshold voltage of the detected signal or a threshold energy of the detected signal is exceeded in the predetermined frequency range.

16. The method of claim 13, further comprising: stopping the semiconductor process equipment when the semiconductor device is determined to be defective, wherein the stopping is performed by a controller.

17. A method for detecting a defect in a semiconductor device, comprising:
detecting, in real time, a signal emitted from a semiconductor device in contact with a chuck table of semiconductor process equipment, wherein the detecting is performed by a sensor disposed on the chuck table of the semiconductor process equipment; and
analyzing the detected signal to determine whether the semiconductor device is defective by using a predetermined criteria, wherein the analyzing is performed by a signal analyzer.

18. The method of claim 17, wherein the sensor is an acoustic emission sensor.

19. The method of claim 17, wherein the chuck table is metal or ceramic.

20. The method of claim 17, wherein the predetermined criteria include a threshold voltage of acoustic waves, a threshold energy of the acoustic waves and a frequency range of the acoustic waves, wherein the semiconductor device is determined to be defective when a threshold voltage of the detected signal and a threshold energy of the detected signal are exceeded in a predetermined frequency range.

21. The method of claim 17, further comprising: stopping the semiconductor process equipment when the semiconductor device is determined to be defective, wherein the stopping is performed by a controller.

22. A method for detecting a defect in a semiconductor device, comprising:
detecting, in real time, a signal emitted from a semiconductor device in contact with a chuck table of semiconductor process equipment, wherein the detecting is performed by at least three sensors disposed on the chuck table of the semiconductor process equipment;
determining whether the semiconductor device is defective based on the detected signal, wherein the determining is performed by a signal analyzer;
storing information about a location of a defect in the semiconductor device, wherein the storing is performed by a controller; and
skipping, based on the stored information, a subsequent process to be performed on the location of the defect by another semiconductor process equipment, wherein the skipping is performed by the controller.

23. The method of claim 22, wherein the location of the defect in the semiconductor device is detected based on signals output from the at least three sensors.
